(19) United States
(12) Patent Application Publication
(10) Pub. No.: US 2024/0022486 A1
(43) Pub. Date: Jan. 18, 2024

(54) STREAMING COMPLEX ENDPOINT EVENTS

(71) Applicant: Netography, Inc., Annapolis, MD (US)

(72) Inventors: Barrett Lyon, Miami, FL (US); Dirk Tennie, Miami, FL (US); Daniel Murphy, Miami, FL (US)

(21) Appl. No.: 18/219,349

(22) Filed: Jul. 7, 2023

Related U.S. Application Data
(60) Provisional application No. 63/388,617, filed on Jul. 12, 2022.

(51) Int. Cl. H04L 43/08

(52) U.S. Cl. CPC H04L 43/08

(57) ABSTRACT

Techniques for streaming complex endpoint events are disclosed. In some embodiments, data associated with detected device events is collected and packaged in a network flow protocol. The collected device event data comprises device data different than network data. Data packaged in the network flow protocol is provided to an external service configured to process the provided data and facilitate applicable optimization and security actions.

### CROSS REFERENCE TO OTHER APPLICATIONS

This application claims priority to U.S. Provisional Patent Application No. 63/388,617 entitled STREAMING COMPLEX ENDPOINT EVENTS filed Jul. 12, 2022, which is incorporated herein by reference for all purposes.

### BACKGROUND OF THE INVENTION

Local agents or dedicated applications on endpoint devices have traditionally handled performance optimization and security services at the device level but are constrained by individual device limitations for providing such services. Thus, there exists a need for improved and more comprehensive techniques for performance optimization and security of endpoint devices.

### BRIEF DESCRIPTION OF THE DRAWINGS

Various embodiments of the invention are disclosed in the following detailed description and the accompanying drawings.

FIG. 1A is a high level block diagram illustrating an embodiment of a network and security operations platform.

FIG. 1B is a high level block diagram illustrating an embodiment of an optimization and security platform.

FIG. 2 is a high level flow chart illustrating an embodiment of a process for providing device event data.

FIG. 3 is a high level flow chart illustrating an embodiment of a process for generating an output in response to processing received data from a device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

Network and security operations are essential for any complex networking environment deployed by an enterprise or organization. A network is typically managed by a network operations center (NOC) via which network monitoring and control are facilitated. Security of a network is typically provided by a security operations center (SOC) via which detection, containment, and remediation of threats and attacks to the network are facilitated. Thus, network and security operations have traditionally been segregated. More recently, there exists an ongoing effort of bringing NOCs and SOCs closer together and leveraging the benefits of combining network and security operations.

A fusion network and security operations platform uniting network operations and security operations is disclosed herein. The disclosed platform comprises an out-of-band, cloud-based service that can be used on any network as a software as a service (SaaS). In some embodiments, the disclosed platform comprises a distributed intrusion detection and prevention system that is complementary to any existing security deployments on a monitored network. The network and security operations platform leverages the relatively unlimited computational power of the cloud to provide an additional layer of control and security to a monitored network, which by itself is limited in computational resources available for network and security operations. A monitored network may be dynamically and automatically optimized and secured, with or without human operator direction or intervention, based on remote monitoring and analysis. Moreover, remote tools associated with the service provide unprecedented monitoring and visualization of the monitored network.

As further described in detail herein, the disclosed platform collects real-time data from a monitored network in a decentralized cloud service where the collected data is analyzed according to a set of one or more proprietary system and/or user-definable custom algorithms. Alerts or actions against any network or security events detected in the analyzed data of the monitored network are automatically provided and/or performed in nearly real-time, for example, via an associated portal having a dashboard with user interface gauges and tools that provide situational awareness of the monitored network, via integration of an associated application programming interface (API) with existing network or security operations tools of the monitored network, and/or via appropriate adjustment of network routing policies by communication with network edge devices such as routers, switches, and cloud services.

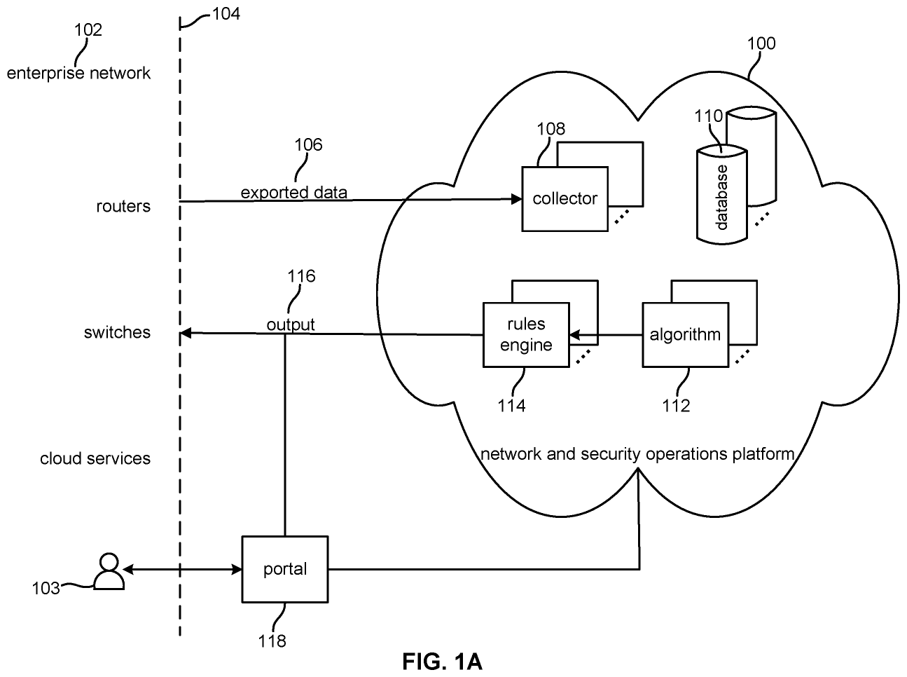

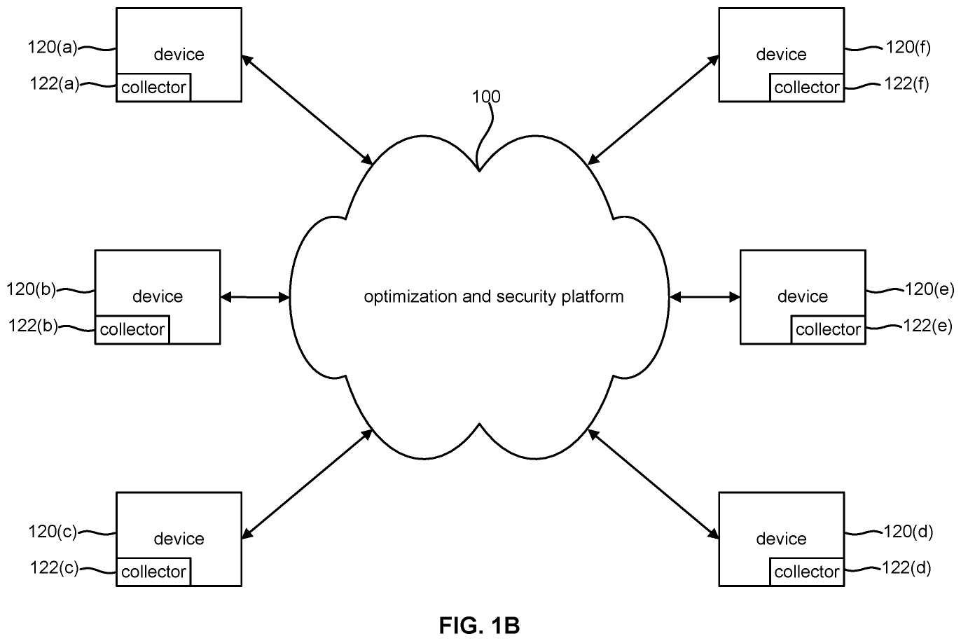

FIG. 1A is a high level block diagram illustrating an embodiment of an architecture of the disclosed network and security operations platform. Generally, network and security operations platform 100 may be employed to automatically defend monitored network 102 from threats and attacks, manage and optimize monitored network 102, and keep operators 103 of monitored network 102 informed of the current state of the network and nodes thereof, all in nearly real-time.

In some embodiments, network and security operations platform 100 is employed to provide an additional layer of security to monitored network 102 beyond any existing security measures already deployed in the network, such as firewalls and access-control lists (ACLs) on edge or border devices of the network. Network and security operations platform 100 may be employed to detect threats and attacks, anomalous usage behaviors, unusual protocols, dangerous networks, etc. Some examples of security events that may be handled by network and security operations platform 100 include distributed denial-of-service (DDoS) attacks, bots and botnets, unauthorized data extraction, port scans, enumeration attempts, and repeated login attempts. Some examples of security services provided by network and security operations platform 100 include cyber forensics, DDoS defenses, attack surface protection, access control list (ACL) management, active Internet Protocol (IP) reputation monitoring, data loss prevention (DLP), and remotely-triggered black hole (RTBH) routing.

Network and security operations platform 100, however, is not limited to detecting and responding to security events and providing security services but may also be employed to detect and respond to network operations events and provide network operations services with respect to monitored network 102. For example, network and security operations platform 100 may be employed to manage network resources and infrastructure, detect network saturation points, modify or optimize routes, ensure quality of service (QoS), manage bandwidth, facilitate billing services, etc.

Although a few components of network and security operations platform 100 are illustrated in FIG. 1A to describe the architecture of the platform, network and security operations platform 100 may generally have any appropriate types, numbers, and combinations of distributed and networked components. For example, although not depicted in FIG. 1A, network and security operations platform 100 comprises a plurality of processing cores and associated memories. Various features of the disclosed network and security operations platform 100 are next described with respect to the network environment illustrated in FIG. 1A.

In the example of FIG. 1A, monitored network 102 comprises a private, enterprise network. Enterprise network 102 has an edge or border 104 defined by the physical devices and virtual services that collectively form the edge or border of the network. In the past, a network edge or border was typically constrained to devices such as routers and switches that were deployed in a controlled, private network environment. As networks have evolved, the network edge or border has also substantially spread across a plurality of external, third-party providers, such as providers of virtual private cloud (VPC) services. Thus, network perimeters have virtually disappeared, and borders have become fractured and decentralized.

By collecting and combining data both from physical edge or border devices comprising a private network (e.g., routers and switches) and from virtual service providers scattered across the Internet, the disclosed network and security operations platform facilitates unifying network and security control with near real-time coordination and situational awareness from a single point, effectively creating a synthetic border for a private, enterprise network. With respect to FIG. 1A, for example, network and security operations platform 100 provides a wholistic view into private enterprise network 102 as well as a defined synthetic edge or border 104 of the network. More specifically, network and security operations platform 100 comprises a central point for receiving data from multiple physical and virtual nodes of network 102 and comprehensively viewing the entire network 102 as well as analyzing received data and facilitating appropriate alerts and actions in response to detected network and security events.

A response by network and security operations platform 100 with respect to a particular node or device of network 102 may be quickly scaled to the entire network. For example, network and security operations platform 100 may preemptively identify and remedy suspicious behavior at other nodes based on a detected security event at one of the network nodes. Moreover, since the services of network and security operations platform 100 are employed by several different private networks, security events detected and corrected on one network may in real-time be prevented or corrected on one or more other networks that network and security operations platform 100 monitors. That is, network and security operations platform 100 has a comprehensive view across multiple private networks, and, thus, has the benefit of being able to more quickly and automatically learn and identify similar events and patterns and respond with appropriate actions.

In the environment of FIG. 1A, network appliances (e.g., routers and switches) and cloud services (e.g., VPC services) that define the edge or border 104 of network 102 are configured to export data 106 useful for network and security operations to network and security operations platform 100. For example, data 106 may comprise lightweight protocols such as network flow data and (e.g., system and/or server) log data. More specifically, in some embodiments, data 106 comprises any data or information that defines network communications but that does not have any payload or other sensitive (e.g., user-specific) information. In some cases, data 106 comprises a substantially continuous stream of data from network 102. However, data 106 may comprise sampled data rather than full packet capture data. Moreover, data 106 may be compressed and/or encrypted. Data 106 may be communicated from private network 102 to network and security operations platform 100 via a public network such as the Internet.

In some embodiments, network and security operations platform 100 is based on network flow data. That is, data 106 comprises flow records exported by network devices such as routers and switches as well as VPC services. Generally, a network flow refers to a communication channel between two end points or hosts bound by a session. More specifically, a network flow is defined as a unidirectional sequence of packets that share the same values for fields such as source IP address, destination IP address, source port, destination port, protocol type, type of service (ToS), and/or ingress interface. That is, a flow specifies a prescribed communication channel for a particular session, and packets sharing the same values for at least a subset of the aforementioned fields belong to the same flow. Many network devices (e.g., routers and switches) and cloud services (e.g., VPC services) are configured to extract measurements and data associated with a given flow and export such data for further analysis. Such a flow record may include various types of information including, for example, timestamps of the first and last packets of the flow, total number of bytes and packets observed in the flow, source/destination IP addresses, source/destination ports, protocol type, type of service (ToS) value, Transmission Control Protocol (TCP) flags, routing information, I/O interface index information, and other details. The precise information extracted from a flow varies by provider and depends on both the device or service that generates the flow data as well as the protocol used to export the information.

Flow data has not been exploited much beyond its typical use for traffic engineering and routing. Flow data has been used in the past to detect DDoS attacks and trigger route changes to dedicated devices configured to handle such attacks. The use of flow data in the security realm has been limited largely because the data is sampled, i.e., the data is incomplete. However, despite being sampled, flow data can be leveraged for a variety of purposes. In some embodiments, the disclosed network and security operations platform 100 is configured to provide a full range of network and security services based on flow data. More specifically, network and security operations platform 100 is configured to receive, process, and store flow data as well as leverage flow data for network and security operations. Moreover, network and security operations platform 100 comprises a single, unified platform that supports a plurality of industry standard flow protocols, including, but not limited to, Internet Protocol Flow Information Export (IPFIX), NetFlow, SFlow, JFlow, VPC Flow Logs, etc. The algorithms and corresponding thresholds employed by network and security operations platform 100 may at least in part be based on the sampling rates of received flow data since different network nodes may have different sampling rates. Moreover, network and security operations platform 100 may be configured to automatically adjust the sampling rates of the flow data of nodes in network 102 via communication with the nodes or through an associated API.

Returning back to the description of the network environment of FIG. 1A, data 106 from network 102 may be received, for example, by one or more distributed data collectors comprising network and security operations platform 100, such as data collector 108. Within network and security operations platform 100, received data 106 and/or parts thereof may be analyzed for network and security events; indexed for searchability; optionally enriched or tagged with applicable metadata or tags such as security, business, and/or performance details; and/or stored in one or more associated databases, such as database 110.

Various appropriate alerts or actions may be initiated or facilitated by network and security operations platform 100 in response to inferences made from analyzing received data 106. Real-time and/or historic monitoring and analysis of received data 106 may be performed by a set of one or more network and/or security algorithms 112. In various embodiments, the set of algorithms 112 may comprise one or more system algorithms generally applied across all data input into network and security operations platform 100, one or more algorithms customized for a prescribed enterprise network 102, one or more user-defined algorithms specified by operators 103 of network 102, or any combination thereof. Algorithms 112 are configured to identify network performance and security events such as anomalies, failures, threats, attacks, etc., in data 106 and generate appropriate alerts. Alerts on any network or security events detected by algorithms 112 are routed to one or more appropriate rules engines, such as rules engine 114. Rules engine 114 implements rules for responding to alerts generated by algorithms 112. That is, rules engine 114 facilitates one or more appropriate actions in response to detected network performance and/or security events by algorithms 112. In various embodiments, events or alerts may be mapped by rules engine 114 to default actions, and/or custom, user-definable actions may be specified for various events or alerts by users of network and security operations platform 100, such as by operators 103 of network 102. Examples of actions facilitated by rules engine 114 include dropping or simply logging a detected event or generated alert, providing a corresponding alert or notification via one or more channels, highlighting or providing another visual indication of a detected event or generated alert with respect to a graphical user interface element or tool used to display related data, facilitating route changes (such as for active blocking) by communicating with affected network nodes, etc. An output 116 generated by network and security operations platform 100 may be directly communicated to one or more applicable network nodes, may be made available and/or presented via a portal 118 of network and security operations platform 100 associated with a prescribed user or network account, and/or may be integrated via an associated API or plug-in with existing network tools or services, such as security information and event management (STEM) services, Slack, Trilio, Webhook, e-mail, short message service (SMS), automated scripts, etc.

A key feature of network and security operations platform 100 is facilitating dynamic and automatic route filtering, manipulation, and/or modification via communication with network edge nodes based on detected network and security events. From a security perspective, for example, this feature of network and security operations platform 100 may be employed for automatically adjusting, changing, or reconfiguring security policies, (VPC) security groups, access control lists (ACLs), etc., at one or more nodes of network 102 based on detected security threats and breaches. In some cases, output 116 comprises streaming real-time filter information (e.g., IP addresses to block) to edge or border nodes of network 102. Network and security operations platform 100 may communicate with network nodes via any appropriate communication protocol, such as Border Gateway Protocol (BGP), Flowspec, APIs, etc. Such protocols for route control have typically only been used by operators 103 of a given network 102 that are on the network 102. However, network and security operations platform 100 leverages remote triggering of such protocols to provide a further layer of control and security as well as to further automate network routing. For example, remote-triggering may be employed to inject a prescribed rule (e.g., route) into a monitored network and force network nodes to drop all traffic with a prescribed next-hop.

Network and security operations platform 100 effectively facilitates a new paradigm for network security by blocking intrusion events a posteriori, i.e., after they have been detected, compared to the typical security ethos of blocking a priori, i.e., before intrusions occur. Attempts to block malicious traffic before the traffic ever enters a network coupled with limitations in available computational resources at network end points has resulted in severe scalability setbacks for existing intrusion detection and prevention systems, especially as rule and signature complexities have grown. Scalability has further been limited because such systems attempt to block all known malicious traffic. However, reputation databases have become too large to be completely incorporated in end point access control lists. Thus, existing systems suffer security vulnerabilities. Such vulnerabilities are addressed by the disclosed network and security operations platform 100. Unprecedented scalability is feasible with the nearly limitless availability of processing and storage resources on the cloud but at the expense of introducing a trivial amount of latency between detection and remediation of an event such as a breach or attack. However, such a latency typically spans a time duration (e.g., of a few seconds) during which malicious activity is unable to detrimentally impact or otherwise significantly compromise the monitored network.

Thus, network and security operations platform 100 facilitates significantly more comprehensive security monitoring while having relatively limitless data processing and storage resource availability for analyzing received data with respect to algorithms, rules, signatures, reputation databases, etc. Network and security operations platform 100 delivers security responses in nearly real-time. That is, post detection, malicious or potentially malicious traffic is blocked using existing network infrastructure such as routers, switches, policy groups, DevOps calls to an associated API, etc. In some embodiments, network and security operations platform 100 only blocks bad or malicious traffic that has been detected, so any generated filters or block lists output by network and security operations platform 100 scale easily with respect to the capacities of access control lists of network nodes. This is in contrast to existing systems that attempt to block all known bad or malicious traffic regardless of whether such traffic has actually been seen on the network and as a result are limited by access control list capacities at network end points. In some embodiments, in order to provide a failsafe against false positives, network and security operations platform 100 is configured to block only individual IP address, i.e., single hosts, instead of large IP address blocks and/or to block only for prescribed (user-definable) time durations. Furthermore, network and security operations platform 100 provides an additional layer of security on top of any existing security measures already deployed on the monitored network. Thus, any malicious traffic not detected or not detected quickly enough may be detected by such existing security systems of the monitored network.

Each network monitored by network and security operations platform 100, such as network 102, has a prescribed user or network account with network and security operations platform 100 and associated portal 118. Portal 118 provides a set of interfaces into network and security operations platform 100 via which various services associated with network and security operations platform 100 may be selected, specified, and/or configured and via which data collected, processed, and stored by network and security operations platform 100 may be aggregated, displayed or visualized (e.g., via charts and graphs), queried, analyzed, or otherwise accessed. A central point is provided by portal 118 from which network operation teams, security operation teams, and developers associated with network 102 can operate their network and security posture. Portal 118 provides a customizable dashboard with user interface elements and tools for identifying, processing, analyzing, displaying, and generally comprehending real-time and historical information associated with monitored network 102. Furthermore, portal 118 provides user interfaces for writing custom scripts or algorithms, specifying or configuring thresholds and rules, and defining alerts or actions for detected events. A unified portal 118 allows different teams (e.g., SOC, NOC, DevOps, and business leaders) to use the same data and toolsets, resulting in reduced mean time to resolve detected network and security events. Moreover, by leveraging an API associated with network and security operations platform 100, different teams can apply unique business logic to their data to create actionable custom tools, for example, for managing security threats, route management, billing systems, etc.

In some embodiments, an easy-to-use, propriety query language is employed to better unify network and security operations platform 100, portal 118, and associated APIs and plug-ins. The query language associated with network and security operations platform 100 may be employed, for example, for tasks such as searching data, alerts, and interfaces; filtering statistics and aggregations; defining custom algorithms to alert on; etc. As previously described, tags may be added to received data records 106. Such tags are available for use with respect to portal 118, an associated API, and the proprietary query language. Software may be created around such simple tags/text. Leveraging tags throughout network and security operations platform 100 is helpful for keeping terminology consistent and to resolve complex data to human readable formats. Tags also allow for multi-tenant separation of data. In addition, tags may be used to associate customers, departments, locations, etc., to an IP address, autonomous system number (ASN), etc.

As described, comprehensive network and security operations tools and services are provided by network and security operations platform 100 as well as its associated portal 118, APIs, and plug-ins. Although some features have been described, the disclosed platform may generally be appropriately scaled and adjusted to provide any needed network and/or security operations services.

As modern networks become more vast and difficult to manage and secure, the disclosed network and security operations platform 100 is becoming even more instrumental in providing unprecedented visibility into increasingly dynamic and complex network architectures. Moreover, the disclosed network and security operations platform 100 provides a central point for facilitating network optimization and security, which is especially useful for distributed network architectures. As further described below, the disclosed features of network and security operations platform 100 may furthermore be scaled to complex endpoint events in order to more comprehensively provide performance optimization and security at a device level using techniques similar to those heretofore described for network optimization and security.

FIG. 1B is a high level block diagram illustrating an embodiment of an optimization and security platform. For example, optimization and security platform 100 of FIG. 1B comprises network and security operations platform 100 of FIG. 1A. As depicted, optimization and security platform 100 comprises a cloud-based service that is external to a private network such as enterprise network 102 of FIG. 1A. In addition to providing optimization and security services at a network level, optimization and security platform 100 of FIG. 1B is furthermore configured to provide optimization and security services at a device level. Data associated with events at devices 120 is streamed in nearly real time to optimization and security platform 100 to provide improved visibility into individual devices 120 so that the devices may be better understood, optimized, and secured. Optimization and security platform 100 may generally ingest any type of exported data from any type of device 120. In various embodiments, devices 120 may comprise endpoint nodes of a private network such as enterprise network 102 of FIG. 1A, edge nodes of a private network such as enterprise network 102 of FIG. 1A, firewalls, routers and switches of content delivery networks, load balancers, web servers, DNS (Domain Name System) servers, or, more generally, any network nodes capable of communicating with optimization and security platform 100.

A collector 122 at a prescribed device 120 may facilitate detection of device events, collection of metadata associated with detected device events, and/or communication of collected data to optimization and security platform 100. Collector 122 may comprise, for example, a locally installed endpoint agent or one or more existing and/or custom kernel features or software modules configured to collect and communicate data associated with detected device events. In various embodiments, collected device event data may comprise file system data, disk access data, memory allocation data, system or function call data, application data, I/O (input/output) data, HTTP (Hypertext Transfer Protocol) access data, log data, or, more generally, any data generated from processes running or executing on an endpoint device 120. In some cases, collected device event data comprises device data different than network data. In some cases, collected device event data may include network data but also includes other local device data that is different than any associated network transaction or flow data. In some embodiments, collected device event data is packaged into a lightweight data structure or transport protocol. For example, in some embodiments, collected device event data is embedded in existing or custom fields of a network flow protocol that is typically used for collecting network traffic information and monitoring network flow.

As previously described with respect to FIG. 1A, optimization and security platform 100 is configured to parse and process network flow data and thus can be easily scaled to process any other data packaged within a network flow data structure in addition to and/or instead of parameters typically included in a network flow record. Data exported from a device 120 may comprise collected device event data and/or applicable network data that is typically included in network flow data. In many cases, combining collected device event data with corresponding network flow data results in a more comprehensive view into a device 120 and allows optimization and security platform 100 to facilitate more in depth analysis, optimization, and security of the device 120. In some embodiments, data exported from a device 120 is summarized or obfuscated so that sensitive information is not included or exposed. In some embodiments, data exported from a device 120 is sampled since, in many cases, a smaller subset of the same or the same type of data is sufficient for the processing and analysis conducted by optimization and security platform 100. In such cases, the sampling rate of exported data may be automatically adjusted by optimization and security platform 100 via communication with device 120 or an associated agent or collector 122 thereof.

Data exported from a device 120 is input into optimization and security platform 100. As previously described with respect to FIG. 1A, data received from a device 120 at optimization and security platform 100 may be parsed, processed, tagged, stored, presented such as via a dashboard of an associated portal, etc. Moreover, optimization and security platform 100 may generate outputs that facilitate appropriate actions in response to any detected performance or security events in analyzed data, such as outputs that facilitate optimizing device operation or performance or remediating security breaches.

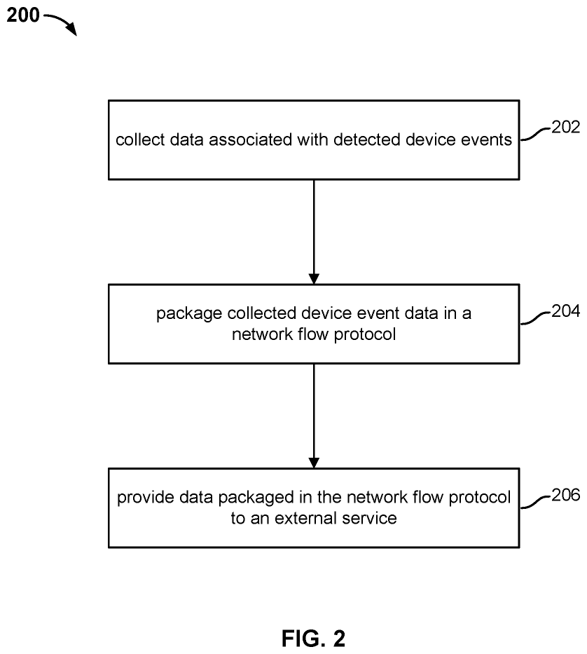

FIG. 2 is a high level flow chart illustrating an embodiment of a process for providing device event data. With respect to FIG. 1B, process 200 of FIG. 2 may be employed by any device 120 configured to communicate with optimization and security platform 100. More specifically, process 200 of FIG. 2 may be employed by collector 122 at a prescribed device 120.

At step 202, data associated with detected device events is collected. For example, the data collected at step 202 comprises metadata associated with detected device events. The data collected at step 202 may comprise device, kernel, application, file, process, and/or user level data and may be sampled. In some cases, the data collected at step 202 comprises device data separate from or different than network data. In some cases, the data collected at step 202 may include network data but also includes other local device or system data that is separate from or different than associated network transaction data. In various embodiments, data may be collected at step 202 for any one or more types of device events, such as file system events or web server access events. In some embodiments, a collector is specifically configured to detect and collect data associated with one or more prescribed types of events at a device at step 202.

At step 204, device event data collected at step 202 is packaged into a lightweight data structure or format such as a network flow protocol. That is, various parameters comprising the collected data are mapped to and used to populate existing or custom fields of the network flow protocol employed at step 204. A network flow protocol has traditionally been used to communicate network data but has not been used to communicate other types of data. However, embedding or including device event data in a network flow protocol comprises a very simple but unique technique for exporting more detailed device information in a streamable format. In some embodiments, only collected device event data is packaged into a network flow protocol or fields thereof at step 204, such as, for instance, when the collected data is associated with strictly local processes at a device. In such cases, the network flow protocol does not include any associated network data. Alternatively, in some embodiments, collected device event data is packaged with corresponding network data at step 204. A process at a device is often not only associated with local data but also communicates data across a prescribed network path. Thus, in such cases, collected local device data is combined or linked with corresponding network transaction data. With the disclosed techniques, network flow protocols may be advantageously leveraged to export collected device event data in addition to and/or instead of network data and provide unprecedented visibility into endpoint devices.

At step 206, the data packaged in the network flow protocol at step 204 is provided or communicated to an external service, i.e., optimization and security platform 100, for further processing and facilitating applicable actions. In some embodiments, the data is streamed at step 206, for example, in nearly real time. In some embodiments, the data provided at step 206 is encrypted. As previously described, the data exported at step 206 may be sampled to reduce resources required in collecting and communicating the data and/or so that the exported data is more manageable.

As one example, process 200 of FIG. 2 may be employed to stream file system data of a device using a network flow protocol. Examples of file system data include file names, file creation and/or modification times, file access information, file permissions information, associated application ports used, etc. File system data may be collected at a device using any appropriate technique. In some cases, file system data is collected at a device using an existing file system API. For example, file system data may be obtained using the inotify or fanotify features of the Linux kernel. In some cases, collector 122 of FIG. 1B comprises a custom software module or kernel feature dedicated to collecting file system data or, more generally, any desired device event data. For example, collector 122 of FIG. 1B may comprise a custom eBPF (Extended Berkeley Packet Filter) module. Such a custom software module may be made open source and, in the future, added as a Linux kernel feature. As described, collected device event data, such as file system data, is packaged into a network flow protocol. Examples of network flow protocols include IPFIX (Internet Protocol Flow Information Export), NetFlow, SFlow, JFlow, Netoflow, Kafka, etc. In some cases, collected data is embedded into existing fields of a network flow protocol. For example, file name and path may be embedded into source and/or destination address fields. Alternatively, custom fields may be added to a network flow protocol. Examples of custom fields that may be added include fields for path, file name, request type, user agent, query, response, process name, process identifier (PID), etc. Adding one or more appropriate custom fields transforms a network flow into a custom flow, such as a file system flow, HTTP access log flow, etc.

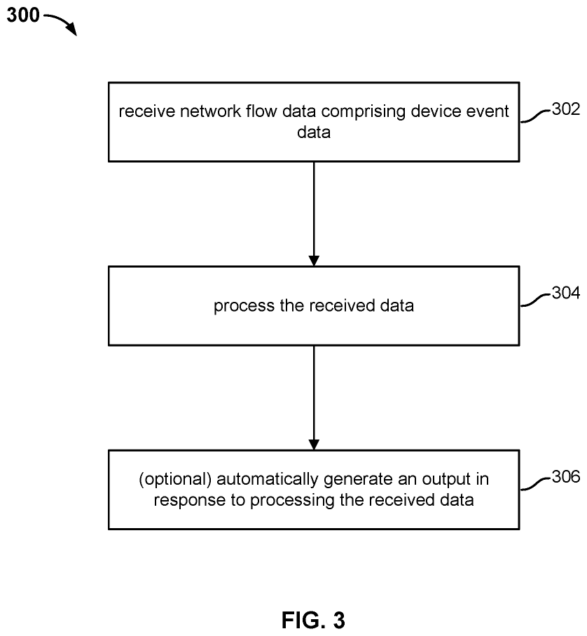

FIG. 3 is a high level flow chart illustrating an embodiment of a process for generating an output in response to processing received data from a device. Process 300 of FIG. 3 may be employed, for example, by a distributed, cloud-based external service such as optimization and security platform 100 of FIG. 1B.

At step 302, network flow data comprising device event data is received from a device. In some cases, the device event data received at step 302 comprises device data separate from or different than network data. In some cases, the device event data received at step 302 may include network data but also includes other local device or system data that is separate from or different than associated network transaction data. In some embodiments, the network flow data received at step 302 furthermore comprises network data in addition to device event data that is not network data. The data received at step 302 may comprise a nearly real time data stream and may be sampled. In some cases, the data received at step 302 is encrypted.

At step 304, the data received at step 302 is processed. In various embodiments, step 304 may include analyzing the data for device performance and/or security events, for example, using various algorithms and rules; generating alerts and notifications on the data based on associated thresholds; indexing the data for searchability; enriching or tagging the data with applicable metadata or tags; storing or persisting the data in databases; presenting and generally making the data available with respect to an associated dashboard or portal; etc.

At optional step 306, an output is automatically generated in response to processing the received data at step 304. For example, the output may be automatically generated at step 306 in response to detecting a device performance or security event at step 304 and may be generated by a rules engine that is configured to map a detected event to an action according to one or more rules. The generated output is communicated to the device and may facilitate optimizing device performance or remediating detected security events at the device.

Process 300 may be employed to facilitate management and optimization of device performance as well as defending the device from threats and attacks. A nearly real-time and, in many cases, completely automatic response is generated as device performance and security events are detected in received data.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
collecting data associated with detected device events, wherein the collected device event data comprises device data different than network data;
packaging the collected device event data in a network flow protocol; and
providing data packaged in the network flow protocol to an external service configured to process the provided data and facilitate applicable optimization and security actions.

2. The method of claim 1, wherein the collected device event data comprises file system data.

3. The method of claim 1, wherein the collected device event data comprises network data.

4. The method of claim 1, wherein the collected device event data is sampled.

5. The method of claim 1, wherein the collected device event data is associated with one or more types of device events.

6. The method of claim 1, wherein packaging the collected device event data in the network is flow protocol comprises populating one or more fields of the network flow protocol with the collected device event data.

7. The method of claim 6, wherein one or more fields of the network flow protocol comprise existing fields of the network flow protocol.

8. The method of claim 6, wherein one or more fields of the network flow protocol comprise custom fields added to the network flow protocol.

9. The method of claim 1, wherein data packaged in the network flow protocol comprises network data in addition to the collected device event data.

10. The method of claim 1, wherein the external service facilitates network level optimization and security.

11. The method of claim 1, wherein the external service facilitates device level optimization and security.

12. A method, comprising:
receiving network flow data comprising device event data of a device at an external service, wherein device event data comprises device data different than network data;
processing the received network flow data at the external service; and
generating an output from the external service in response to processing the received network flow data that facilitates applicable optimization and security actions at the device.

13. The method of claim 12, wherein device event data comprises network data.

14. The method of claim 12, wherein received network flow data comprises network data.

15. The method of claim 12, wherein device event data comprises file system data.

16. The method of claim 12, wherein device event data populates one or more existing or custom fields of a network flow protocol comprising the received network flow data.

17. A system, comprising:
a processor configured to:
collect data associated with detected device events, wherein the collected device event data comprises device data different than network data;
is package the collected device event data in a network flow protocol; and
provide data packaged in the network flow protocol to an external service configured to process the provided data and facilitate appropriate optimization and security actions; and
a memory coupled to the processor and configured to provide the processor with instructions.

18. A system, comprising:
one or more databases of an external service configured to store received network flow data comprising device event data of a device, wherein device event data comprises device data different than network data; and
one or more processors of the external service configured to:
process the received network flow data at the external service; and
generating an output from the external service in response to processing the received network flow data that facilitates applicable optimization and security actions at the device.

19. A computer program product embodied in a non-transitory computer readable medium and comprising computer instructions for:
collecting data associated with detected device events, wherein the collected device event data comprises device data different than network data;
packaging the collected device event data in a network flow protocol; and
providing data packaged in the network flow protocol to an external service configured to process the provided data and facilitate appropriate optimization and security actions.

20. A computer program product embodied in a non-transitory computer readable medium and comprising computer instructions for:
receiving network flow data comprising device event data of a device at an external is service, wherein device event data comprises device data different than network data;
processing the received network flow data at the external service; and
generating an output from the external service in response to processing the received network flow data that facilitates applicable optimization and security actions at the device.
